(19) United States
(12) Patent Application Publication
(10) Pub. No.: US 2012/0185220 A1
(43) Pub. Date: Jul. 19, 2012

(54) DETERMINING SLUG CATCHER SIZE USING SIMPLIFIED MULTIPHASE FLOW MODELS

(75) Inventor: Mack Edward Shippen, Houston, TX (US)

(73) Assignee: SCHLUMBERGER TECHNOLOGY CORPORATION, HOUSTON, TX (US)

(21) Appl. No.: 13/009,153

(22) Filed: Jan. 19, 2011

(51) Int. Cl. G06G 7/50; G06F 17/10

(52) U.S. Cl. 703/2

(57) ABSTRACT

An integrated workflow to determine slug catcher size in a pipeline network of an oilfield using successive steady-state and/or simplified transient simulation such that a comprehensive analysis is automatically performed in a short amount of time. In particular, the workflow simultaneously considers several scenarios such that the most limiting case can be used to determine the slug catcher size. Further, the limiting operational parameters that impose the most limiting case may be constrained by the user to mitigate the worst case slug catcher size requirement. Based on the short computation time required, the workflow may be executed iteratively to adjust the constraint while a final slug catcher size is selected by the user. The final slug catcher size is then implemented in the production system with the final constraint included in the operational plan of the production system.

### BACKGROUND

Oilfield operations, such as surveying, drilling, wireline testing, completions, production, planning and oilfield analysis, are typically performed to locate and gather valuable downhole fluids. Specifically, the oilfield operations assist in the production of hydrocarbons. One such oilfield operation is the analysis of the oilfield network. A typical oilfield includes a collection of wellsites. Hydrocarbons flow from the collection of wellsites through a series of pipes to a processing facility. The series of pipes are often interconnected, thereby forming an oilfield network.

Pipelines that transport both gas and liquids simultaneously, known as a two-phase flow, may operate in a flow regime known as slugging flow or slug flow. Under the influence of gravity, liquid will tend to settle on the bottom portion of the pipeline, while the gas occupies the top portion of the pipeline. Under certain operating conditions the gas and liquid are not evenly distributed throughout the pipeline but travel as large plugs with mostly liquid or mostly gas through the pipeline. These large plugs are commonly referred to as slugs.

Slugs exiting the pipeline can overload the gas/liquid handling capacity of the plant at the pipeline outlet, as the slugs are often produced at a much larger rate than the equipment is designed for. Slugs can be generated by different mechanisms in a pipeline as discussed below.

Terrain slugging may be caused by the elevation of the pipeline, which follows the elevation of the ground or sea bed. Liquid can accumulate at a low point of the pipeline until sufficient pressure builds up behind it. Once the liquid is pushed out of the low point, the liquid can form a slug.

Hydrodynamic slugging is caused by gas flowing at a fast rate over a slower flowing liquid phase. The gas will form waves on the liquid surface, which may grow to bridge the whole cross-section of the line. This creates a blockage on the gas flow, which travels as a slug through the line.

Riser-based slugging, also known as severe slugging, is associated with the pipeline risers often found in offshore oil production facilities. Liquids accumulate at the bottom of the riser until sufficient pressure is generated behind the liquids to push the liquids over the top of the riser, overcoming the static head. Behind the slug of liquid follows a slug of gas, until sufficient liquids have accumulated at the bottom to form a new liquid slug.

Pigging slugs are caused by pigging operations in the pipeline. Pigging in the maintenance of pipelines refers to the practice of using pipeline inspection gauges or “pigs” to perform various operations on a pipeline without stopping the flow of the product in the pipeline. These operations include but are not limited to cleaning and inspecting the pipeline. This is accomplished by inserting the pig into a pig launcher, which is a funnel shaped Y section in the pipeline. The launcher is then closed and the pressure of the product in the pipeline is used to push it along down the pipe until it reaches the receiving trap referred to as the pig catcher. The pig is typically designed to push all or most of the liquids contents of the pipeline to the outlet. The pushing intentionally creates a liquid slug.

Slugs formed by terrain slugging, hydrodynamic slugging or riser-based slugging are periodical in nature. Whether a slug is able to reach the outlet of the pipeline depends on the rate at which liquids are added to the slug at the front (i.e., in the direction of the flow) and the rate at which liquids leave the slug at the back. Some slugs will grow as they travel the pipeline, while others are dampened and disappear before reaching the outlet of the pipeline.

A slug catcher is a vessel with a sufficient buffer volume to store the largest liquid surge expected from the upstream system. The slug catcher is typically located between the outlet of the pipeline and the processing equipment. The buffered liquids can be drained to the processing equipment at a much slower rate to prevent overloading the system. As slugs are a periodical phenomenon, the slug catcher should be emptied before the next slug arrives.

### SUMMARY

In general, in one embodiment, determining slug catcher size using simplified multiphase flow models relates to a method for selecting a size of a slug catcher in a pipeline network configured for extracting and transporting multiphase fluid from a reservoir in a subterranean formation. The method includes (i) obtaining a network model of the pipeline network, wherein the network model comprises a geometry of the pipeline network and characteristics of an equipment associated with the pipeline network, (ii) obtaining operational parameters of the pipeline network, wherein the operational parameters relate to extraction and transportation activities of the multiphase fluid, (iii) determining, by a processor of a computer system, a plurality of slug catcher sizes of the slug catcher including (1) determining a first slug catcher size of the plurality of slug catcher sizes based on a hydrodynamic slugging scenario of the network model using a first subset of values of the operational parameters, wherein the first slug catcher size is a first function of travel distance of the multiphase fluid and is determined based on a probabilistic model of the extraction and transportation activities and (2) determining a second slug catcher size of the plurality of slug catcher sizes based on a pigging scenario of the network model using a second subset of values of the operational parameters, wherein the second slug catcher size is determined based on liquid holdup of the multiphase fluid caused by performing a pigging operation in the pipeline network, wherein the first slug catcher size and the second slug catcher size are determined by performing a successive steady-state analysis of the multiphase fluid using a first mass conservation equation, an energy conservation equation, and a momentum conservation equation of the multiphase fluid that are based on a steady-state, (iv) generating, by the processor, a hydrodynamic slugging plot and a pigging analysis plot based on the first slug catcher size and the second slug catcher size, respectively, (v) generating, by the processor and using selected values of the operational parameters from a user, a combined scenario plot based on the hydrodynamic slugging plot and the pigging analysis plot, and (vi) displaying the combined scenario plot for the user, wherein the size of the slug catcher is selected from the plurality of slug catcher sizes by the user based on an evaluation of the combined scenario plot.

Other aspects of determining slug catcher size using simplified multiphase flow models will be apparent from the following description and the appended claims.

### BRIEF DESCRIPTION OF DRAWINGS

The appended drawings illustrate several embodiments of determining slug catcher size using simplified multiphase flow models and are not to be considered limiting of its scope, for determining slug catcher size using simplified multiphase flow models may admit to other equally effective embodiments.

FIG. 1 shows a field having a pipeline network for production operations, in which embodiments of determining slug catcher size using simplified multiphase flow models may be implemented.

FIG. 2 shows a schematic view of a portion (or region) of the field (100) of

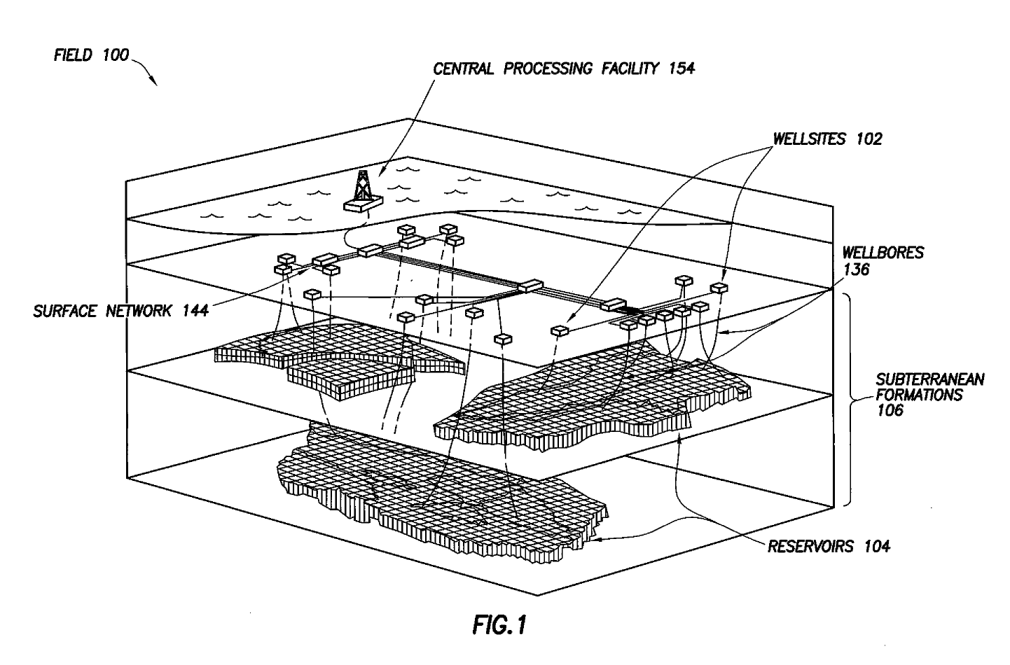

FIG. 1, in which embodiments of determining slug catcher size using simplified multiphase flow models may be implemented.

FIG. 3 shows a schematic network model of an example pipeline network for determining slug catcher size using simplified multiphase flow models in accordance with one or more embodiments.

FIG. 4 shows an example method for determining slug catcher size using simplified multiphase flow models in accordance with one or more embodiments.

FIGS. 5.1-5.6 each show an example display screenshot for determining slug catcher size using simplified multiphase flow models in accordance with one or more embodiments.

FIG. 6 shows a computer system in which one or more embodiments of determining slug catcher size using simplified multiphase flow models may be implemented.

### DETAILED DESCRIPTION

Embodiments are shown in the above-identified drawings and described below. In describing the embodiments, like or identical reference numerals are used to identify common or similar elements. The drawings are not necessarily to scale and certain features and certain views of the drawings may be shown exaggerated in scale or in schematic in the interest of clarity and conciseness.

The design of liquids handling facilities at the receiving end of multiphase pipelines involves determining the appropriate size of liquid separators and slug catchers. This is especially relevant to offshore platforms, where the high cost of added weight to the platform is compounded with the potential of a large slug overwhelming the liquids handling capacity and shutting down the entire system. Sizing of the slug catcher generally depends on several factors and may include consideration of severe slugging, riser slugging, hydrodynamic slugging, pigging, ramp-up surges, etc. Evaluation of these scenarios generally involves independent assessments conducted with either steady-state or fully transient simulation models.

Embodiments of determining slug catcher size using simplified multiphase flow models provide an integrated workflow to evaluate each scenario using successive steady-state and/or simplified transient simulation such that a comprehensive analysis may be automatically performed in a short amount of time (e.g., seconds instead of hours). Specifically, the workflow is used to determine an appropriate slug catcher size based on several criteria. Unlike previous methods used in the industry, the workflow simultaneously considers several scenarios such that the most limiting case can be used to determine slug catcher size. Additionally, manual post-processing separate from the integrated simulation is not required to collectively compare the scenarios. Finally, a simplified transient model may be applied for the gradual ramp-up scenario, which allows the user to determine the slug catcher size as a function of ramp-up rate with added accuracy. In one or more embodiments, the limiting operational parameters that impose the most limiting case may be constrained by the user to mitigate the worst case slug catcher size requirement. For example, the flow rate or the rate of input ramp-up may be constrained to avoid an excessive slug catcher size requirement. Based on the short computation time required, the workflow may be executed iteratively to adjust the constraint while a final slug catcher size is selected by the user. The final slug catcher size is then implemented in the production system with the final constraint included in the operational plan of the production system.

FIG. 1 shows a field (100) for performing production operations. In particular, a pipeline network (i.e., surface network (144)) is positioned at various locations along the field (100) for extracting and transporting fluid from reservoirs (104) in the subterranean formations (106). For example, the field (100) may be an oilfield where hydrocarbons are extracted from the reservoir and transported using the pipeline network. Generally, the hydrocarbons may include a liquid phase and a gas phase depending on the specific composition of the hydrocarbon. The transportation of the liquid phase and the gas phase form a multiphase flow along the pipeline network. As shown, the oilfield has a plurality of wellsites (102) operatively connected to a central processing facility (154). The oilfield configuration of FIG. 1 is not intended to limit the scope of the invention. A portion or all of the oilfield may be on land and/or sea. Also, while a single oilfield with a single processing facility and a plurality of wellsites is depicted, any combination of one or more oilfields, one or more processing facilities and one or more wellsites may be present.

Specifically, the oilfield (100) includes multiple wellsites (102) having equipment that forms a wellbore (136) into the earth, which may use steam injection to produce a hydrocarbon (e.g., oil, gas, etc.); rely on a gas lift to produce a hydrocarbon; or produce a hydrocarbon on the basis of natural flow. The wellbores extend through subterranean formations (106) including reservoirs (104). These reservoirs (104) contain fluids, such as hydrocarbons. The wellsites draw fluid from the reservoirs and pass them to the processing facilities via surface network (144). The surface network (144) has tubing and control mechanisms for controlling the flow of fluids from the wellsite to the processing facility (154).

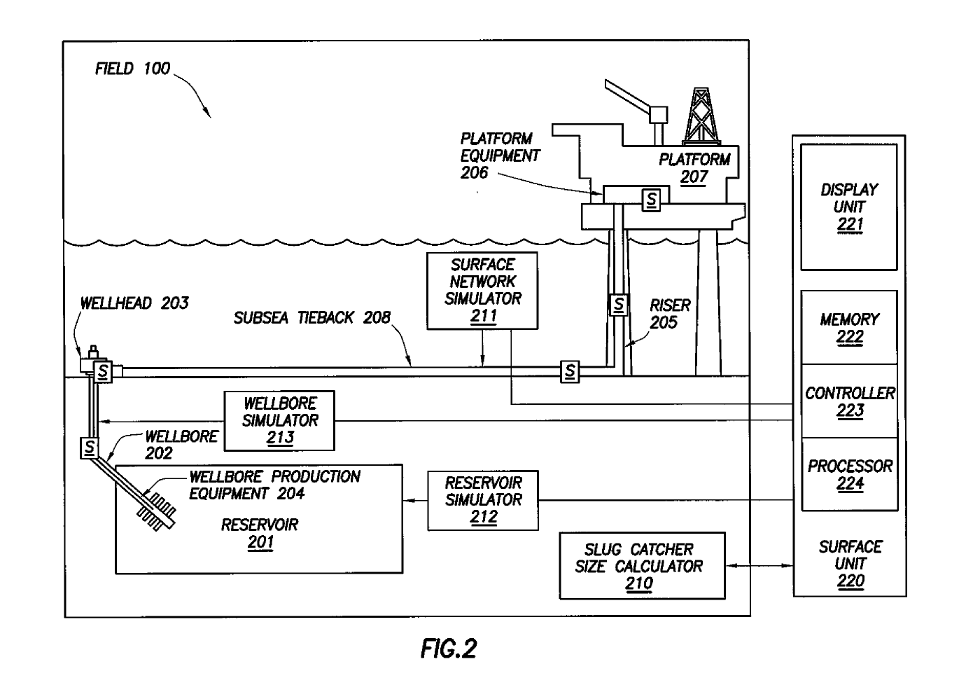

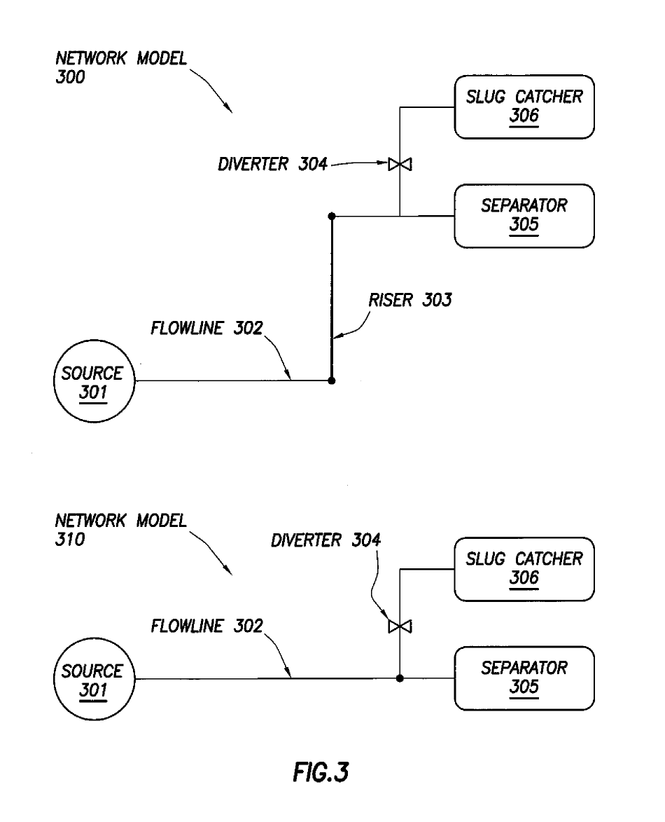

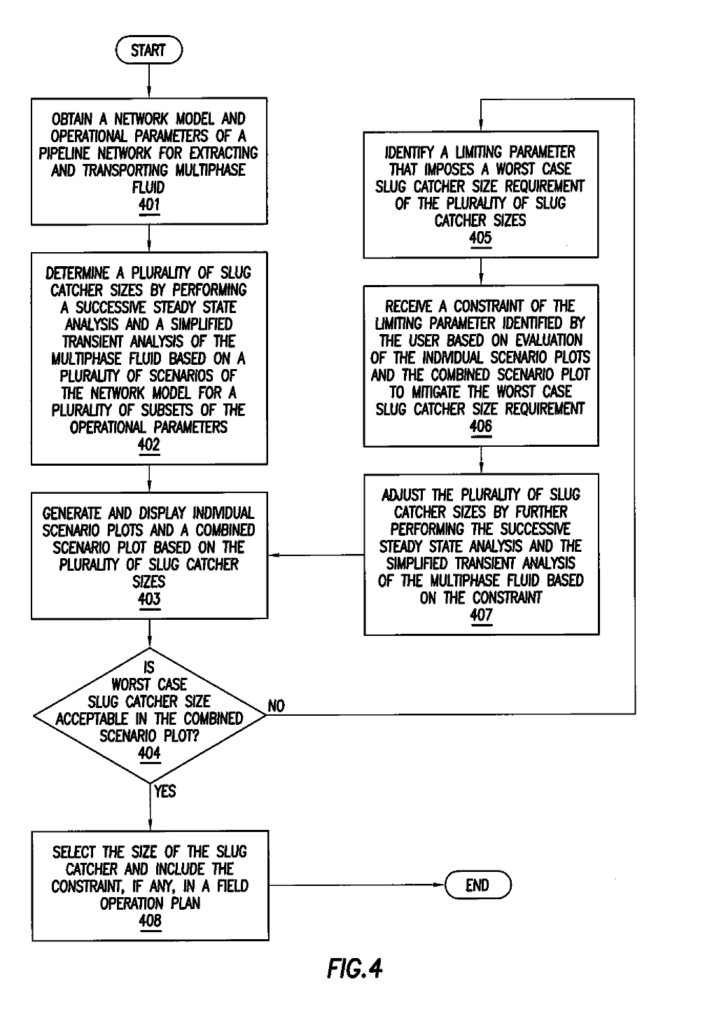

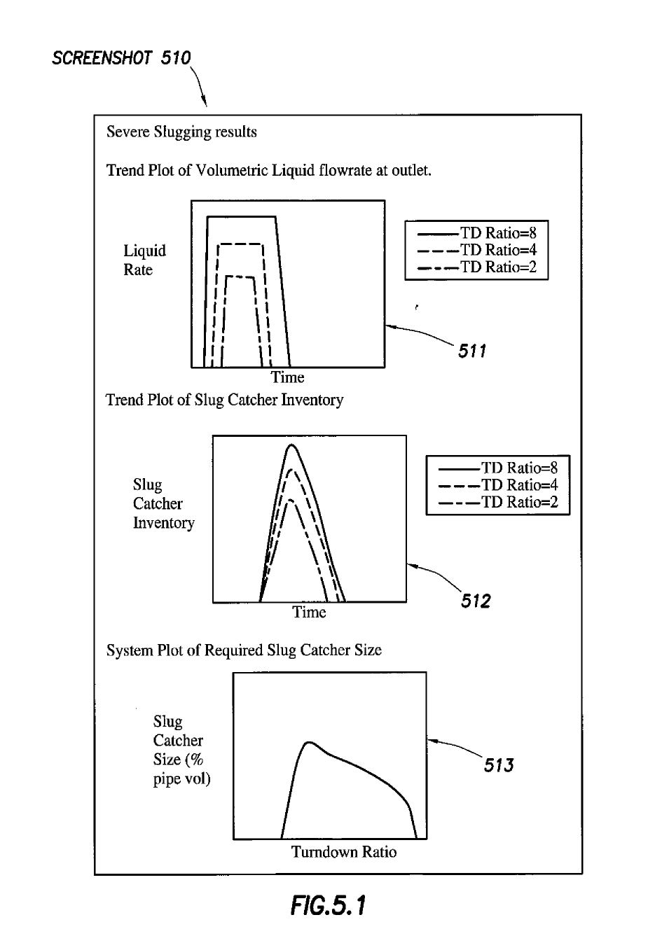

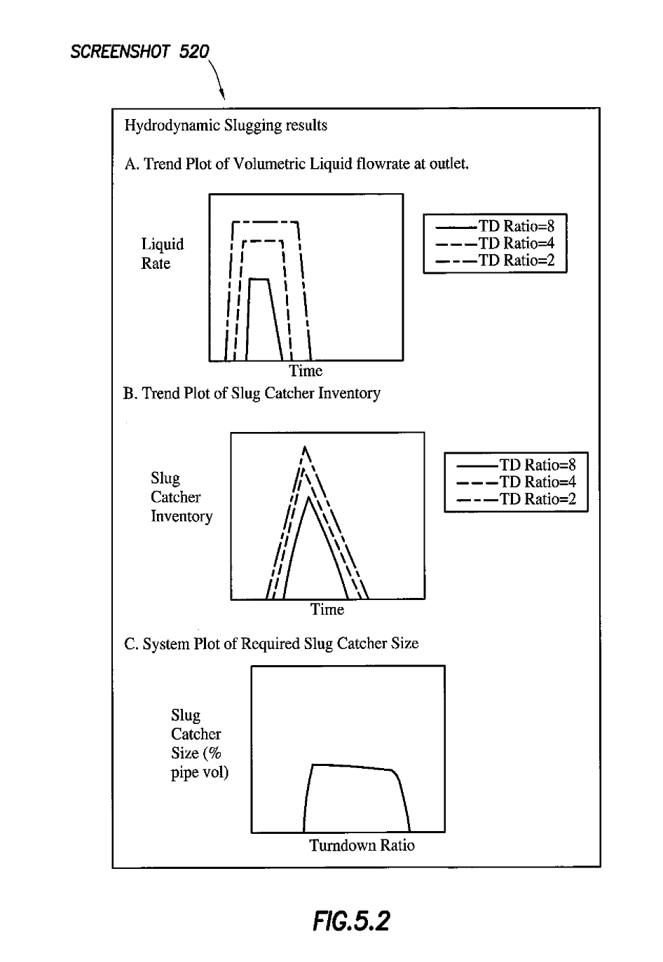

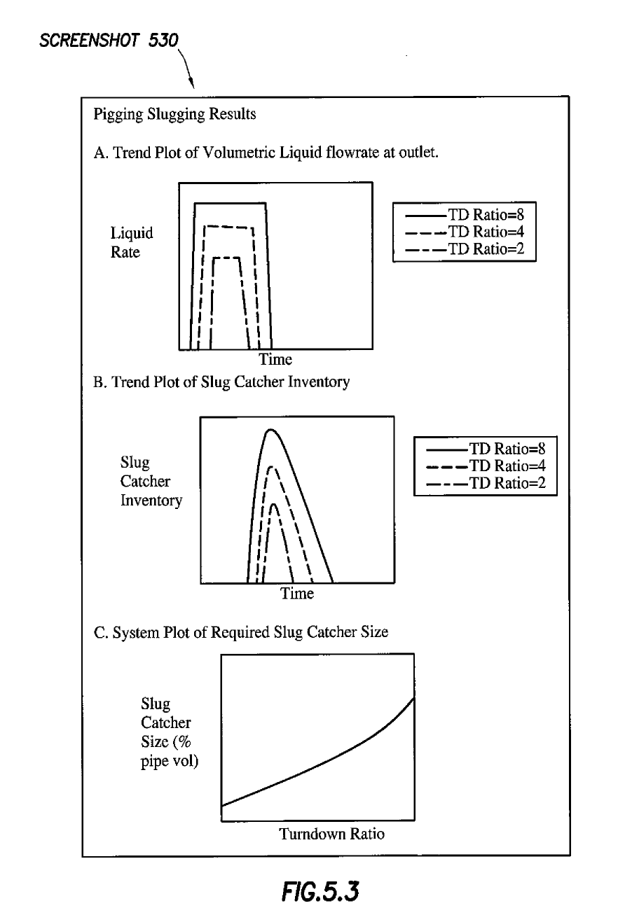

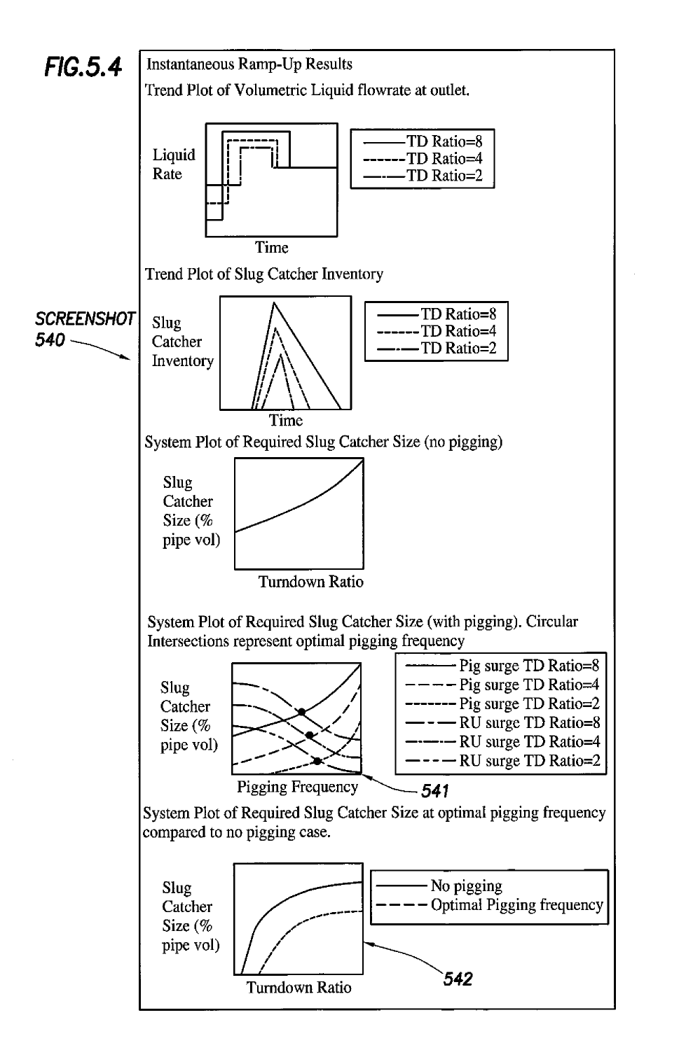

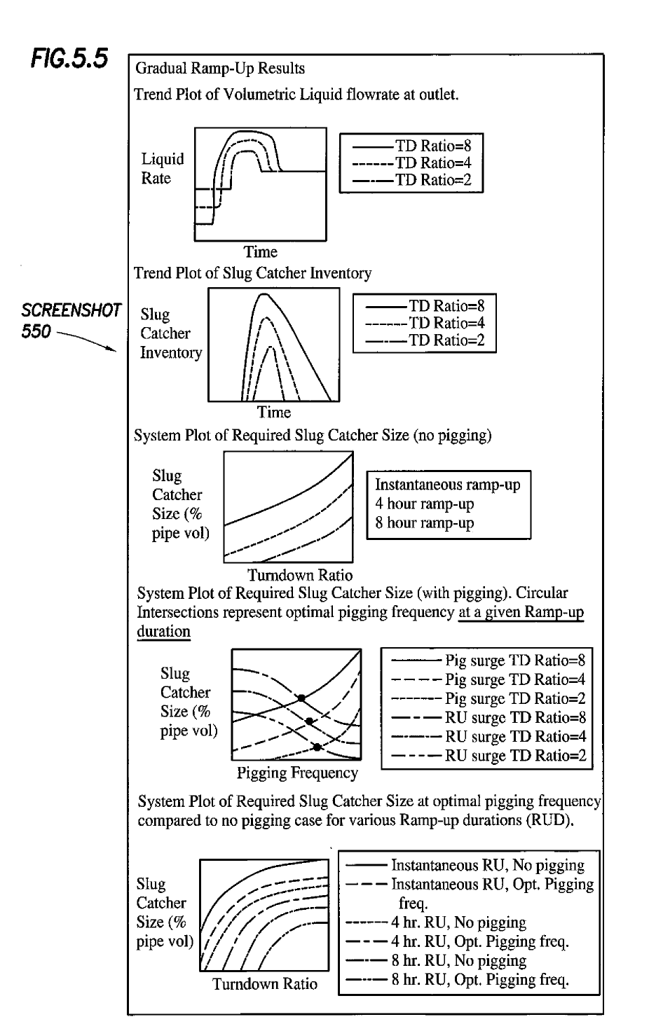

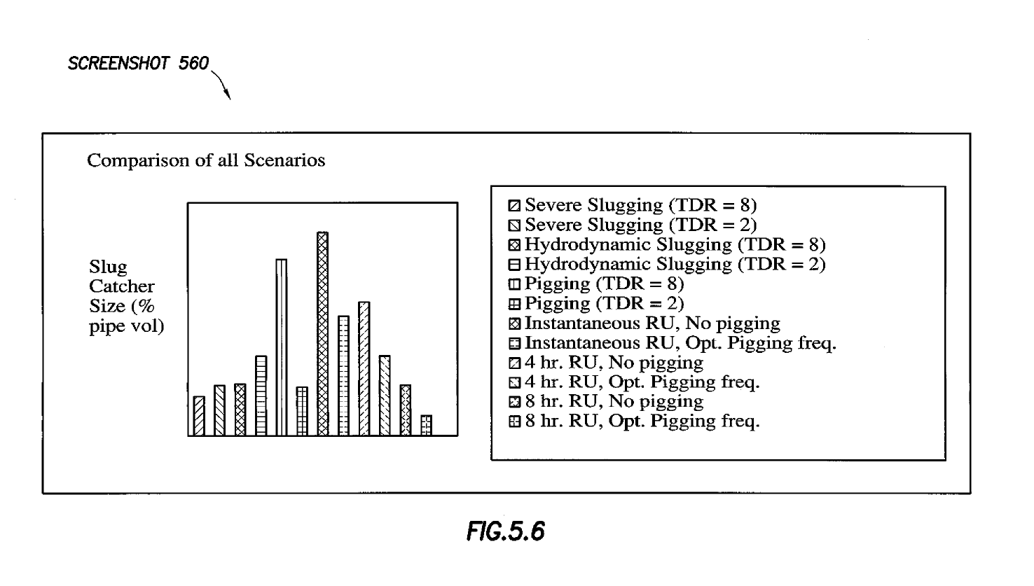

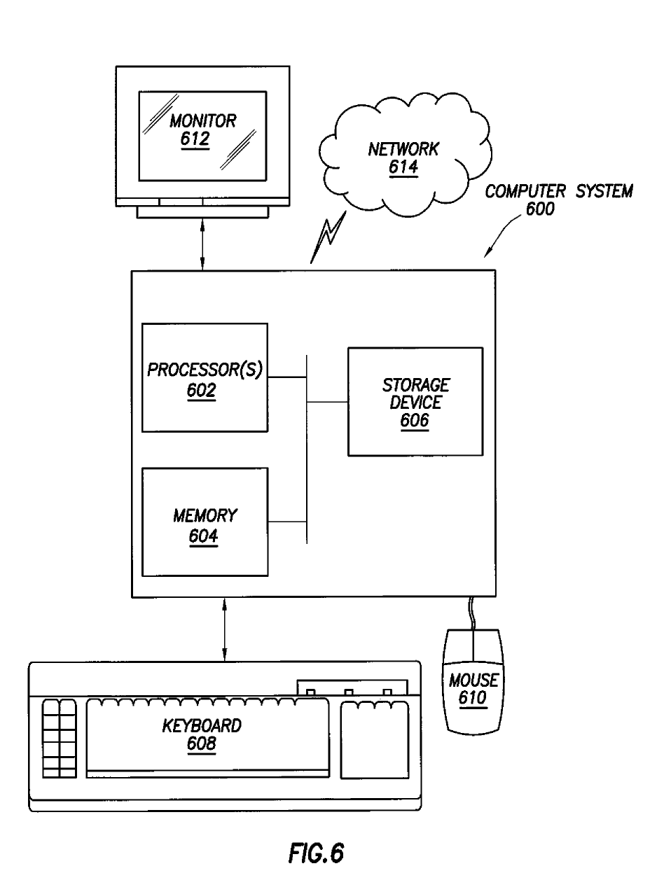

FIG. 2 shows a schematic view of a portion (or region) of the field (100) of FIG. 1, depicting a wellbore (202) with associated wellhead (203), subsea tieback (208) with associated riser (205), and platform equipment (206) in an offshore platform (207), which may be related to the wellsites (102), surface network (144), and processing facility (154), respectively, depicted in FIG. 1. Although not specifically shown, the platform equipment (206) may include a slug catcher, diverter, separator, etc. In particular, the slug catcher may be implemented based on modeling results generated by the slug catcher size calculator (210). In one or more embodiments, the slug catcher size calculator (210) is configured to execute the workflow method described in reference to FIG. 4 below. The wellbore (202) extends into the earth therebelow for extracting hydrocarbons from the reservoir (201), which may be related to the reservoirs (104) depicted in FIG. 1. Although the offshore platform is shown as an example processing facility in FIG. 2, the method and examples described below may also be practiced in a land based processing facility.

As shown, the wellbore (202) has already been drilled, completed, and prepared for production from the reservoir (201). Wellbore production equipment (204) extends from the wellhead (203) of the wellbore (202) to the reservoir (201) to draw fluid to the surface. The wellhead (203) is operatively connected to the offshore platform (207) via the subsea tieback (208) and riser (205). Fluid flows from the reservoir (201), through the wellbore (202), and into the subsea tieback (208). The fluid then flows from the subsea tieback (208) to the platform equipment (206) via the riser (205). As noted above, the fluid (e.g., hydrocarbons) includes a liquid phase and a gas phase based on specific contents of the fluid. The transportation of liquid phase and the gas phase form a multiphase flow along the subsea tieback (208) to the platform equipment (206) via the riser (205).

As further shown in FIG. 2, sensors (S) are located about the field (100) to monitor various parameters during field operations. The sensors (S) may measure, for example, pressure, temperature, flow rate, composition, and other parameters of the reservoir, wellbore, surface network, process facilities and/or other portions (or regions) of the field operation. In one or more embodiments, the sensors (S) are operatively connected to a surface unit (220) for collecting data therefrom.

One or more surface units (e.g., surface unit (220)) may be located at the field (100), or linked remotely thereto. The surface unit (220) may be a single unit, or a complex network of units used to perform the necessary modeling/planning/management functions (e.g., determining the slug catcher size) throughout the field (100). The surface unit may be a manual or automatic system. The surface unit may be operated and/or adjusted by a user. The surface unit is adapted to receive and store data. The surface unit may also be equipped to communicate with various field equipment. The surface unit may then send command signals to the oilfield in response to data received or modeling performed. For example, the command signals may be used to control the flow rate and/or the rate of input ramp-up consistent with the aforementioned constraint for mitigating an excessive slug catcher size requirement.

As shown in FIG. 2, the surface unit (220) has computer facilities, such as memory (222), controller (223), processor (224), and display unit (221), for managing the data. The data is collected in memory (222), and processed by the processor (224) for analysis. Data may be collected from the oilfield sensors (S) and/or by other sources. For example, oilfield data may be supplemented by historical data collected from other operations, or user inputs.

The analyzed data (e.g., based on modeling performed) may then be used to make operational decisions. A transceiver (not shown) may be provided to allow communications between the surface unit (220) and the field (100). The controller (223) may be used to actuate mechanisms at the field (100) via the transceiver and based on these decisions. In this manner, the field (100) may be selectively adjusted based on the data collected. These adjustments may be made automatically based on computer protocol and/or manually by an operator. In some cases, slug catcher sizes, input flow rates, and/or pigging frequencies are adjusted to select optimum operating conditions or to avoid problems.

To facilitate the processing and analysis of data, simulators may be used to process the data for modeling various aspects of the field operation. Specific simulators are often used in connection with specific field operations, such as surface network, wellbore, or reservoir simulation. Data fed into the simulator(s) may be historical data, real time data or combinations thereof. Simulation through one or more of the simulators may be repeated or adjusted based on the data received.

As shown, the field operation is provided a reservoir simulator (212), a wellbore simulator (213), and a surface network simulator (211). The reservoir simulator (212) simulates hydrocarbon flow through the reservoir rock and into the wellbores. The wellbore simulator (213) and surface network simulator (211) simulates hydrocarbon flow through the wellbore and the surface network (e.g., subsea tieback (208), riser (205), etc.) of pipelines. The network simulator PIPESIM™ (a registered trademark of Schlumberger Technology Corporation, Houston, Tex.) is an example of such a wellbore simulator and surface network simulator. Further, some of the simulators shown in FIG. 2 may be separate or combined, depending on the available systems. In one or more embodiments, the reservoir simulator (212), wellbore simulator (213), and surface network simulator (211) are used in conjunction with the slug catcher size calculator (210) in executing the workflow method described in reference to FIG. 4 below.

FIG. 3 shows a schematic network model of an example pipeline network. Specifically, network model (300) includes source (301), flowline (302), riser (303), diverter (304), separator (305), and slug catcher (306). For example, source (301) may represent the reservoir (201), wellbore (202), and wellhead (203) depicted in FIG. 2. Flowline (302) and riser (303) may represent subsea tieback (208) and riser (205) depicted in FIG. 2. Diverter (304), separator (305), and slug catcher (306) may represent the platform equipment (206) depicted in FIG. 2. In one or more embodiments, the network model (300) describes the pipeline network topology and characteristics of various equipment. The method for determining slug catcher size using simplified multiphase flow models is able to deal with a pipeline network system comprising any of the above items or any combination thereof, given a user defined set of operating parameters for various production scenarios such as hydrodynamic fluid transportation, pipeline pigging operation, sudden or gradual flow rate ramp-up, etc. Those skilled in the art will appreciate that the method described herein applies equally to other configurations of pipeline networks. For example, the network model (310) represents a system where the surface network is at the same altitude level as the processing facilities and includes essentially the same components of the network model (300) with the exception of the riser (303).

FIG. 4 shows an example method for determining slug catcher size using simplified multiphase flow models in accordance with one or more embodiments. For example, the method shown in FIG. 4 may be practiced using the system described in reference to FIG. 2 above for the field (100) described in reference to FIG. 1 above. Specifically, the method shown in FIG. 4 may be performed by the slug catcher size calculator (210) depicted in FIG. 2 above. In one or more embodiments of the invention, one or more of the elements shown in FIG. 4 may be omitted, repeated, and/or performed in a different order. Accordingly, embodiments of determining slug catcher size using simplified multiphase flow models should not be considered limited to the specific arrangements of elements shown in FIG. 4.

Initially in Element 401, a network model and operational parameters of the pipeline network are obtained. In particular, the pipeline network includes a slug catcher, such as one depicted in FIG. 2 above. In one or more embodiments, the network model represents a geometry of the pipeline network and characteristics of equipment (e.g., diverter, separator, slug catcher, etc.) associated with the pipeline network. Further, the operational parameters relate to extraction and transportation activities of the multiphase fluid and may include boundary conditions of pressures, rates, and phase ratios; injection rates and pressures; start and end flow rates for ramp-up operation; duration of ramp-up operation; pig leakage efficiency; pigging frequency; steady-state separator liquid volume ratio; separator volume; separator liquid volume ratio at diversion point to the slug catcher; separator drainage rate; slug catcher drainage rate; slug catcher size safety factor; and any combination thereof. In one or more embodiments, the operational parameters, or a portion thereof, may be based on historical data from previous production operations, derived data from specification analysis, reference data from operations of similar systems, reservoir simulation data and/or process simulation data, etc. For example, one or more of the boundary conditions of pressures, rates, and phase ratios, injection rates and pressures, start and end flow rates for ramp-up operation, duration of ramp-up operation, etc. may be based on reservoir simulation modeling production operation over an extended period (e.g., 10 years, 20 years, etc.).

In Element 402, various slug catcher sizes of the slug catcher are determined by performing a successive steady-state analysis and a simplified transient analysis of the multiphase fluid based on multiple scenarios of the network model. Specifically, the successive steady-state analysis uses a mass conservation equation, an energy conservation equation, and a momentum conservation equation of the multiphase fluid based on a steady-state of the multiphase fluid in the pipeline network. Further, the simplified transient analysis uses a mass conservation equation of the multiphase fluid that is time dependent and uses an energy conservation equation and a momentum conservation equation of the multiphase fluid that are based on a steady-state of the multiphase fluid. In particular, in the simplified transient analysis, the mass conservation equation for each pipe segment in the pipeline network is a function of time, implying that the mass of the fluid is not constant for each point in the pipeline network. Based on the steady-state or the time dependent designations of the conservation equations, a variety of multiphase flow correlations and heat transfer methods may be applied accordingly. Throughout this disclosure, “performing a successive steady-state analysis” refers to performing a variety of multiphase flow correlations and heat transfer methods using a mass conservation equation, an energy conservation equation, and a momentum conservation equation of the multiphase fluid based on a steady-state of the multiphase fluid in the pipeline network. The term “steady-state” refers to the condition that the mass rate of fluid entering into the system is equivalent to the mass rate of fluid exiting the system. In this case, no mass accumulates anywhere in the system; however, pressure and temperature may still change along the system. Further, “performing simplified transient analysis” refers to performing a variety of multiphase flow correlations and heat transfer methods using a mass conservation equation of the multiphase fluid that is time dependent and using an energy conservation equation and a momentum conservation equation of the multiphase fluid that are based on a steady-state of the multiphase fluid. Said in other words, the mass conservation equation contains time dependent coefficients. Further, simplified transient analysis applies steady-state flow models to determine the pressures and temperatures of the fluid in the system. In this case, the mass of the fluid entering the system is not necessarily equal to the mass of the fluid exiting the system, implying that the fluid may accumulate. Accordingly, the mass conservation equation is time-dependent while the momentum and energy conservation equations (used to calculate pressure and temperature) are not time-dependent.

In one or more embodiments, each scenario is simulated for a range of values of applicable operational parameters (i.e., a subset of the operational parameters) by modeling the multiphase fluid using a black-oil model or a compositional equation of state. For example, a severe slugging scenario is applicable to a pipeline network having a riser configuration, pig leakage efficiency and pigging frequency are applicable in a pigging scenario, start and end flow rates of a ramp-up operation and duration of the ramp-up operation are applicable in a ramp-up scenario, etc. Additional details of determining slug catcher sizes for particular scenarios are discussed below.

In one or more embodiments, various slug catcher sizes are determined as a function of applicable operational parameters in the severe slugging scenario. Generally, severe slugging is most prevalent for cases where a long flowline precedes a riser, especially for cases in which the flowline inclination angle is negative going into the riser. The presence of severe slugging may be determined using a method known to those skilled in the art, such as described in Pots et al., “Severe Slug Flow in Offshore Flowline/Riser Systems,” published as SPE paper 13723, November 1987.

In one or more embodiments, if severe slugging is detected to occur, the slug volume is assumed to be equivalent to the volume of the riser and the slug catcher size is determined based on (e.g., the same as, 110% of etc.) the volume of the riser such that the slug catcher is able to receive a volume of liquid that is at least equal to the volume of the riser. In one or more embodiments, the user defined separator properties (e.g., described in Element 401 above) are analyzed to determine if liquid should be diverted to the slug catcher in the severe slugging scenario. The need to divert fluids is based on a calculation to determine if the volume of the slug results in a separator volume higher than a defined maximum limit (e.g., a fractional volume of the separator) that is determined by tracking (via successive steady-state) the inventory of the separator. The inventory of the separator is the volume in minus volume out during the slug event. The volume in is the flow rate of the fluid whereas the volume out is the drainage rate of the separator. At the end of each successive steady-state timestep, the final volume is calculated. If this volume exceeds the separator limit, the timesteps leading to this violation will be reduced until the time at which the limit is reached is determined.

In the case where such diversion is required, duration, frequency, and size of severe slugging event is calculated based on the velocity of the multiphase fluid at the outlet (i.e., the diversion point) assuming steady-state conditions of the multiphase fluid. The duration of the slugging event is determined by the total volume of the slug divided by the volumetric liquid flow rate at the outlet during the slug event. The volumetric flow rate at the outlet during the event is assumed to be the steady-state velocity multiplied by the cross sectional area of the pipe. Accordingly, the volume of the slug catcher liquid inventory is determined as a function of time based on the initial inventory plus the inlet volumetric liquid flowrate of the multiphase fluid throughout the duration minus the liquid volumetric drainage rate. Calculation of such duration, frequency, and size may use a method known to those skilled in the art, such as described in Fan et al., “Use of Steady-State Multiphase Models to Approximate Transient Events,” published as SPE paper 123934, October 2009.

In one or more embodiments, various slug catcher sizes are determined as a function of applicable operational parameters in the hydrodynamic slugging scenario. Generally, most multiphase production systems will experience hydrodynamic slugging, which is described in Scott et al., “Advances in Slug Flow Characterization for Horizontal and Slightly inclined Pipelines”, published as SPE 20628, September 1990. Hydrodynamic slugs grow while progressing along the pipeline; therefore, long pipelines may produce very large hydrodynamic slugs. In one or more embodiments, a network simulator (e.g., PIPESIM™) is used to calculate the mean slug length as a function of distance traveled. A probabilistic model is then applied to calculate the largest slug size for various occurrence probabilities (e.g., one out of 10, 100 and 1000 occurrences), for example using a method known to those skilled in the art, such as described in Brill et al., “Analysis of Two-Phase Tests in Large Diameter Prudhoe Bay Flowlines,” published as SPE paper 8305, 1979. For example, the 1/1000 slug length (i.e., occurring one out of 1000 cases) may be used to determine a slug catcher volume requirement.

In one or more embodiments, the user defined separator properties (e.g., described in Element 401 above) are analyzed to determine if liquid should be diverted to the slug catcher in the hydrodynamic scenario. In the case where such diversion is required, duration, frequency, and size of hydrodynamic event for the chosen occurrence probability (e.g., 1/1000 slug length) is calculated based on the velocity of the multiphase fluid at the outlet (i.e., the diversion point) assuming steady-state conditions of the multiphase fluid. Accordingly, the volume of the slug catcher liquid inventory is determined as a function of time based on the initial inventory plus the inlet volumetric liquid flowrate of the multiphase fluid throughout the duration minus the liquid volumetric drainage rate. The size and frequency of hydrodynamic event may be calculated using a method known to those skilled in the art, such as described in Brill et al., “Analysis of Two-Phase Tests in Large Diameter Prudhoe Bay Flowlines,” published as SPE paper 8305, 1979.

In one or more embodiments, various slug catcher sizes are also determined as a function of applicable operational parameters in the pigging scenario. Generally, as a pipeline is pigged, a volume of liquid builds up ahead of the pig and is expelled into the slug catcher as the pig approaches the exit. The pig may be modeled (e.g., using PIPESIM™) as traveling at the mean fluid velocity and, thus, the volume of liquid that collects ahead of the pig is a function of the degree of slip between the gas and liquid phases (Le., magnitude of liquid holdup). For example, PIPESIM™ reports this volume as the Sphere Generated Liquid Volume.

In one or more embodiments, the user defined separator properties (e.g., described in Element 401 above) are analyzed to determine if liquid should be diverted to the slug catcher in the pigging scenario. In the case where such diversion is required, a duration of pig generated slug event is calculated based on the velocity of the multiphase fluid at the outlet (i.e., the diversion point) assuming steady-state conditions of the multiphase fluid. Accordingly, the volume of the slug catcher liquid inventory is determined as a function of time based on the initial inventory plus the inlet volumetric liquid flow rate of the multiphase fluid throughout the duration minus the liquid volumetric drainage rate.

In one or more embodiments, optimum pigging frequency (i.e., the optimum frequency for performing pigging operation) is calculated for the pigging scenario as the cycle frequency such that a pigging operation performed at the end of the cycle results in a slug catcher inventory reaching a specified limit. The optimal pigging frequency is the frequency at which the slug catcher size requirement to handle a pig generated slug is equivalent to the slug catcher size requirement needed to handle a ramp-up slug where the initial conditions for the ramp-up are based on the volume of liquid in the line at a time corresponding to the frequency of the pigging operation—that is, the initial condition at the start of the pigging operation at a given frequency. For example, more details of determining optimal pigging frequency may be found in Xiao et al., “Sizing Wet-Gas Pipelines and Slug Catchers with Steady-State Multiphase Flow Simulations,” ASME Journal, June 1998.

In one or more embodiments, various slug catcher sizes are determined as a function of applicable operational parameters in the ramp-up scenario. Generally, when the flow rate into a pipeline increases (i.e., ramps up), the overall liquid holdup decreases as the gas phase sweeps out the liquid phase more efficiently. Ramp-up may be instantaneous if, for example, new wells are brought online which have a minimum stable operating rate or if a pump is activated that has a minimum stable operating rate. Ramp-up may be gradual if wellhead or manifold chokes are used to regulate the inlet flow rates in such a way that stable flow is maintained.

When a sudden rate increase (i.e., instantaneous ramp-up scenario) occurs, the liquid volume in the pipeline is accelerated resulting in a surge. The size of the surge is influenced by the sensitivity of liquid holdup with respect to the overall flow rate. In one or more embodiments, for the instantaneous ramp-up scenario, a simple material balance approach is applied to estimate the volume of the associated surge using a successive steady-state method. For example, the method described in Cunliffe, “Prediction of Condensate Flow Rates in Large Diameter High Pressure Wet Gas Pipelines,” APEA Journal, 1978 may be used.

In one or more embodiments, the user defined separator properties (e.g., described in Element 401 above) are analyzed to determine if liquid should be diverted to the slug catcher in the instantaneous ramp-up scenario. In the case where such diversion is required, individual complete steady-state simulations and post processing are performed to track location of surge fronts and velocities of the multiphase fluid based on an initial holdup profile). Accordingly, the volume of the slug catcher liquid inventory is determined as a function of time throughout the ramp-up duration.

In one or more embodiments, optimum pigging frequency (i.e., the optimum frequency for performing pigging operation) is calculated for the instantaneous ramp-up scenario (where the pipeline network is routinely pigged) as the cycle frequency such that a pigging operation performed at the end of the cycle results in a slug catcher inventory reaching a specified limit.

When a rate increase is gradual (i.e., a gradual ramp-up scenario), the duration of ramp-up is divided into a series of time-steps for performing analysis. In one or more embodiments, the user defined separator properties (e.g., described in Element 401 above) are analyzed to determine if liquid should be diverted to the slug catcher in the gradual ramp-up scenario. In the case where such diversion is required, a single simplified transient simulation is executed based on an initial holdup profile using an inlet production rate that is varied at each time-step according to the gradual ramp-up profile. Accordingly, the volume of the slug catcher liquid inventory is determined as a function of time throughout the ramp-up duration minus the drainage rate.

In one or more embodiments, optimum pigging frequency (i.e., the optimum frequency for performing pigging operation) is calculated for the gradual ramp-up scenario (where the pipeline network is routinely pigged) such that a pigging operation performed at the end of the cycle results in a slug catcher inventory reaching a specified limit.

In one or more embodiments, one or more of the scenarios above may be omitted in the analysis performed in Element 402 based on a user selection. For example, the severe slugging scenario may be omitted for processing facilities without a riser. Similarly, other scenarios may be deemed as non-applicable based on user input.

In Element 403, individual scenario plots and a combined scenario plot are generated and displayed based on the slug catcher sizes determined in Element 402 above. In one or more embodiments, individual scenario plots include a severe slugging analysis plot, a hydrodynamic slugging plot, a pigging analysis plot, an instantaneous ramp-up analysis plot, and a gradual ramp-up analysis plot for the corresponding scenarios. In one or more embodiments, each of such individual scenario plots includes a trend plot and a system plot. Specifically, the trend plot includes calculated output liquid rate and calculated slug catcher inventory as parameterized functions of time with respect to turn down ratio. In addition, the system plot includes calculated slug catcher size as function of the turn down ratio. In one or more embodiments, the combined scenario is generated based on all such individual scenario plots and includes selected slug catcher sizes from various individual scenario plots. For example, the selection may be based on pre-determined configuration or user specification. Accordingly, the individual scenario plots and combined scenario plot are displayed to the user for comprehensive review of slug catcher size requirements from all such scenarios. More details of such trend plot and system plot for various analyzed scenarios are described in reference to FIGS. 5.1-5.6 below.

As noted above, the individual scenario plots and combined scenario plot may be generated and displayed in a short time (e.g., seconds) once the operational parameters are specified in Element 401. In this case, the user may use the generated individual scenario plots and combined scenario plot as a tool to perform a scenario analysis for mitigating potentially excessive slug catcher size requirement versus constraining one or more limiting factors in the operational parameters. For example, the operational parameters based on simulated reservoir production over an extended period of time (e.g., 10 years, 20 years, etc.) may be associated with large ranges of variations in their values due to varying extraction and transportation conditions over time. Such large ranges of variations in operational parameter values may impose an excessively large size requirement for the slug catcher. Scenario analysis based on rapid generation of the individual scenario plots and combined scenario plot may be used to identify appropriate constraints in the operational parameter values to mitigate such excessive size requirements. In one or more embodiments, the iteration for such scenario analysis includes Elements 403 through 408 as described below.

In one or more embodiments, one or more of the plots above may be omitted in the analysis performed in Element 403 based on the scenarios selected in Element 402. For example, the severe slugging analysis plot may be omitted for processing facilities without a riser because the severe slugging scenario was not generated.

In Element 404, a determination is made as to whether the worst case (i.e., largest) slug catcher size shown in the combined scenario plot is acceptable to the user or not. If it is acceptable to the user, the method proceeds to Element 408 where the worst case slug catcher size is selected to be used in implementing the slug catcher in the pipeline network and any constraint defined by the user through the iteration loop is included in a field operation plan to be consistent with the selected slug catcher size.

If the worst case (i.e., largest) slug catcher size shown in the combined scenario plot is not acceptable to the user, the method proceeds to Element 405. In Element 405, a limiting parameter is identified from the values of applicable operational parameters for the particular scenario that exhibits the worst case slug catcher size in the combined scenario plot. Specifically, the limiting parameter imposes the worst case slug catcher size requirement in this particular scenario. In one or more embodiments, the limiting parameter is identified automatically by analyzing the individual scenario plots and combined scenario plot. In one or more embodiments, the limiting parameter is identified by the user manually evaluating the individual scenario plots and combined scenario plot. For example, a flow rate or rate of input ramp-up may be identified as the limiting factor that imposes the worst case slug catcher size requirement in the instantaneous ramp-up scenario.

In Element 406, a constraint of the limiting parameter identified above is received from the user to mitigate the worst case slug catcher size requirement. For example, the user may define a constraint on the range of flow rate or rate of input ramp-up to mitigate the worst case slug catcher size requirement in the instantaneous ramp-up scenario.

In Element 407, prior to the user selecting the size of the slug catcher from various displayed plots, the successive steady-state analysis and/or the simplified transient analysis of the multiphase fluid is further performed based on the user defined constraint to adjust the calculated slug catcher sizes for the scenario(s) affected by the user defined constraints. For example, adjusted slug catcher sizes are determined as a function of applicable operational parameters in the instantaneous ramp-up scenario if the user defined constraints include a constraint on the range of flow rate or rate of input ram up in the instantaneous ramp-up scenario. Once the adjusted slug catcher sizes are determined, the method returns to the Element 403 for another iteration of the scenario analysis.

FIGS. 5.1- 5.6 each show example screenshots for determining slug catcher size using simplified multiphase flow models in accordance with one or more embodiments.

FIG. 5.1 depicts a screenshot (510) of example severe slugging results described in reference to FIG. 4 above. As shown, the screenshot (510) includes (i) a trend plot (511) of volumetric liquid flow rate at outlet (i.e., of the pipeline feeding the slug catcher) as a function of time with respect to various values of turn down (TD) ratios, (ii) a trend plot (512) of slug catcher inventory as a function of time, which is essentially an integral of plot (511) considering applicable slug catcher drainage rate, and (iii) a system plot (513) of required slug catcher size as a function of turn down ratio.

FIG. 5.2 depicts a screenshot (520) of example hydrodynamic slugging results described in reference to FIG. 4 above. As shown, the screenshot (520) includes similar configurations of trend plots and a system plot as those shown in FIG. 5.1.

FIG. 5.3 depicts a screenshot (530) of example pigging slugging results described in reference to FIG. 4 above. As shown, the screenshot (530) includes similar configurations of trend plots and a system plot as those shown in FIG. 5.1.

FIG. 5.4 depicts a screenshot (540) of example instantaneous ramp-up results described in reference to FIG. 4 above. As shown, the screenshot (540) includes similar trend plots and system plot as those shown in FIG. 5.1. Further, the screenshot (540) includes additional system plot (541) of required slug catcher size as a function of pigging frequency with respect to various values of turn down (TD) ratios. In particular, the system plot (541) includes both slug catcher size requirements imposed by a pigging slug (e.g., based on information from FIG. 5.3) as well as imposed by a ramp-up slug. In addition, the screenshot (540) includes additional system plot (542) of required slug catcher size as a function of turn down ratio at an optimal pigging frequency compared to no pigging case.

FIG. 5.5 depicts a screenshot (550) of example gradual ramp-up results described in reference to FIG. 3 above. As shown, the screenshot (550) includes similar configurations of trend plots and system plots as those shown in FIG. 5.4.

FIG. 5.6 depicts a screenshot (560) of a combined scenario plot described in reference to FIG. 3 above. As shown, the screenshot (560) includes selected slug catcher sizes from various individual scenario plots. Specifically, calculated slug catcher sizes are selected from system plots of the severe slugging scenario, hydrodynamic slugging scenario, and pigging scenario with turn down ratio of 8 and 2. In addition, calculated slug catcher sizes are selected from system plots of the instantaneous ramp-up scenario and several gradual ramp-up scenarios (i.e., with a 4 hour ramp-up period and an 8 hour ramp-up period) with and without a pigging operation. In one or more embodiments, the turn down ratio (e.g., TD ratio of 8 and 2) and gradual ramp-up periods (e.g., 8 hours and 4 hours) for constructing the combined scenario plot are pre-determined for the workflow. In one or more embodiments, the turn down ratio (e.g., TD ratio of 8 and 2) and gradual ramp-up periods (e.g., 8 hours and 4 hours) for constructing the combined scenario plot are determined based on user input. In one or more embodiments, the combined scenario plot may be constructed based on parameters other than the turn down ratio and gradual ramp-up periods. Based on the combined scenario plot depicted in the screenshot (560), the user may select the worst case slug catcher size of the instantaneous ramp-up scenario without pigging to be implemented in the processing facility for production. Alternatively, the user may identify a constraint on the ramp-up rate to mitigate the excessive requirement of the worst case slug catcher size and re-execute the workflow based on the constraint.

Embodiments of determining slug catcher size using simplified multiphase flow models may be implemented on virtually any type of computer regardless of the platform being used. For instance, as shown in FIG. 6, a computer system (600) includes one or more processor(s) (602) such as a central processing unit (CPU), integrated circuit, or other hardware processor, associated memory (604) (e.g., random access memory (RAM), cache memory, flash memory, etc.), a storage device (606) (e.g., a hard disk, an optical drive such as a compact disk drive or digital video disk (DVD) drive, a flash memory stick, etc.), and numerous other elements and functionalities typical of today's computers (not shown). The computer (600) may also include input means, such as a keyboard (608), a mouse (610), or a microphone (not shown). Further, the computer (600) may include output means, such as a monitor (612) (e.g., a liquid crystal display LCD, a plasma display, or cathode ray tube (CRT) monitor). The computer system (600) may be connected to a network (614) (e.g., a local area network (LAN), a wide area network (WAN) such as the Internet, or any other similar type of network) via a network interface connection (not shown). Those skilled in the art will appreciate that many different types of computer systems exist (e.g., desktop computer, a laptop computer, or any other computing system capable of executing computer readable instructions), and the aforementioned input and output means may take other forms, now known or later developed. Generally, the computer system (600) includes at least the minimal processing, input, and/or output means necessary to practice one or more embodiments.

Further, those skilled in the art will appreciate that one or more elements of the aforementioned computer system (600) may be located at a remote location and connected to the other elements over a network. Further, one or more embodiments may be implemented on a distributed system having a plurality of nodes, where each portion of the implementation (e.g., various components of the dual domain analysis tool) may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform one or more embodiments may be stored on a non-transitory computer readable storage medium such as a compact disc (CD), a diskette, a tape, or any other computer readable storage device.

The systems and methods provided relate to the acquisition of hydrocarbons from an oilfield. It will be appreciated that the same systems and methods may be used for performing subsurface operations, such as mining, water retrieval and acquisition of other underground fluids or other geomaterials materials from other fields. Further, portions of the systems and methods may be implemented as software, hardware, firmware, or combinations thereof.

While embodiments of the invention have been described with respect to a limited number of embodiments, those skilled in the art, having benefit of this disclosure, will appreciate that other embodiments may be devised which do not depart from the scope of the invention as disclosed herein. Accordingly, the scope of embodiments of the invention should be limited only by the attached claims.

What is claimed is:

1. A method for selecting a size of a slug catcher in a pipeline network configured for extracting and transporting multiphase fluid from a reservoir in a subterranean formation, comprising:
obtaining a network model of the pipeline network, wherein the network model comprises a geometry of the pipeline network and characteristics of an equipment associated with the pipeline network;
obtaining operational parameters of the pipeline network, wherein the operational parameters relate to extraction and transportation activities of the multiphase fluid;
determining, by a processor of a computer system, a plurality of slug catcher sizes of the slug catcher, comprising:
determining a first slug catcher size of the plurality of slug catcher sizes based on a hydrodynamic slugging scenario of the network model using a first subset of values of the operational parameters, wherein the first slug catcher size is a first function of travel distance of the multiphase fluid and is determined based on a probabilistic model of the extraction and transportation activities, and
determining a second slug catcher size of the plurality of slug catcher sizes based on a pigging scenario of the network model using a second subset of values of the operational parameters, wherein the second slug catcher size is determined based on liquid holdup of the multiphase fluid caused by performing a pigging operation in the pipeline network,
wherein the first slug catcher size and the second slug catcher size are determined by performing a successive steady-state analysis of the multiphase fluid using a first mass conservation equation, an energy conservation equation, and a momentum conservation equation of the multiphase fluid that are based on a steady-state,
generating, by the processor, a hydrodynamic slugging plot and a pigging analysis plot based on the first slug catcher size and the second slug catcher size, respectively;
generating, by the processor and using selected values of the operational parameters from a user, a combined scenario plot based on the hydrodynamic slugging plot and the pigging analysis plot; and
displaying the combined scenario plot for the user, wherein the size of the slug catcher is selected from the plurality of slug catcher sizes by the user based on an evaluation of the combined scenario plot.

2. The method of claim 1, further comprising:
identifying a limiting parameter from the first subset and the second subset of values of the operational parameters, wherein the limiting parameter imposes a worst case slug catcher size requirement for the plurality of slug catcher sizes;
receiving, from the user, a constraint of the limiting parameter to mitigate the worst case slug catcher size requirement, wherein the constraint is identified based on at least the evaluation of the combined scenario plot by the user;
adjusting, prior to the user selecting the size of the slug catcher, the first slug catcher size and the second slug catcher size by further performing the successive steady-state analysis of the multiphase fluid based on the constraint; and
including the constraint in a field operation plan corresponding to the size of the slug catcher selected by the user.

3. The method of claim 1,
wherein determining the plurality of slug catcher sizes further comprises:
determining a third slug catcher size of the plurality of slug catcher sizes based on an instantaneous ramp-up scenario of the network model using a third subset of values of the operational parameters, wherein the third slug catcher size is determined based on sensitivity of liquid holdup with respect to overall flow rate induced by increases of input flow rate of the pipeline network, and
wherein determining the third slug catcher size comprises performing the successive steady-state analysis of the multiphase fluid using the first mass conservation equation, the energy conservation equation, and the momentum conservation equation of the multiphase fluid that are based on the steady-state, and
wherein the method further comprises:
generating an instantaneous ramp-up analysis plot based on the third slug catcher size,
wherein the combined scenario plot is further generated based on the instantaneous ramp-up analysis plot.

4. The method of claim 3,
wherein determining the plurality of slug catcher sizes further comprises:
determining a fourth slug catcher size of the plurality of slug catcher sizes based on a gradual ramp-up scenario of the network model using a fourth subset of values of the operational parameters, wherein the fourth slug catcher size is determined based on sensitivity of liquid holdup with respect to overall flow rate induced by increases of input flow rate of the pipeline network, and
wherein determining the fourth slug catcher size comprises performing a simplified transient analysis of the multiphase fluid using a second mass conservation equation of the multiphase fluid that is time dependent and using the energy conservation equation and the momentum conservation equation of the multiphase fluid that are based on the steady-state, and
wherein the method further comprises:
generating a gradual ramp-up analysis plot based on the fourth slug catcher size,
wherein the combined scenario plot is further generated based on the gradual ramp-up analysis plot.

5. The method of claim 4,
wherein determining the plurality of slug catcher sizes further comprises:
determining a fifth slug catcher size of the plurality of slug catcher sizes based on a severe slugging scenario of the network model using a fifth subset of values of the operational parameters, wherein the fifth slug catcher size is determined based on a volume of a riser in the pipeline network; and
wherein determining the fifth slug catcher size comprises performing the successive steady-state analysis of the multiphase fluid using the first mass conservation equation, the energy conservation equation, and the momentum conservation equation of the multiphase fluid that are based on the steady-state, and
wherein the method further comprises:
generating a severe slugging analysis plot based on the fifth slug catcher size,
wherein the combined scenario plot is further generated based on the severe slugging analysis plot.

6. The method of claim 5, further comprising:
iteratively identifying a limiting parameter from the first subset, the second subset, the third subset, the fourth subset, and the fifth subset of values of the operational parameters, wherein the limiting parameter imposes a worst case slug catcher size requirement for the plurality of slug catcher sizes;
iteratively receiving a constraint of the iteratively identified limiting parameter from the user, wherein the iteratively received constraint is identified by the user based on an iterative evaluation of the combined scenario plot;
adjusting, prior to the user selecting the size of the slug catcher, the first slug catcher size, the second slug catcher size, the third slug catcher size, the fourth slug catcher size, and the fifth slug catcher size by iteratively performing the successive steady-state analysis and the simplified transient analysis of the multiphase fluid based on the iteratively received constraint; and
including a version of the iteratively received constraint in a field operation plan corresponding to the size of the slug catcher selected by the user.

7. The method of claim 5,
wherein each of the hydrodynamic slugging plot, the pigging analysis plot, the instantaneous ramp-up analysis plot, the gradual ramp-up analysis plot, and the severe slugging analysis plot comprises a trend plot and a system plot,
wherein the trend plot comprises calculated output liquid rate as a second function of time and calculated slug catcher inventory as a third function of time,
wherein the second function and the third function are parameterized functions with respect to a turn down ratio, and
wherein the system plot comprises a calculated slug catcher size as a fourth function of the turn down ratio.

8. The method of claim 1, wherein determining the plurality of slug catcher sizes is based on modeling the multiphase fluid using at least one selected from a group consisting of a black-oil model and a compositional equation of state.

9. The method of claim 1, wherein the operational parameters of the pipeline network comprise at least one selected from a group consisting of boundary conditions of pressures, rates, and phase ratios; injection rates and pressures; start and end flow rates for ramp-up operation; duration of a ramp-up operation; pig leakage efficiency; pigging frequency; a steady-state separator liquid volume ratio; a separator volume; a separator liquid volume ratio at a diversion point of the slug catcher; a separator drainage rate; a slug catcher drainage rate; and a slug catcher size safety factor.

10. A system for selecting a size of a slug catcher in a pipeline network configured for extracting and transporting multiphase fluid from a reservoir in a subterranean formation, comprising:
a repository configured to store a network model comprising a geometry of the pipeline network and characteristics of equipment associated with the pipeline network, wherein the pipeline network is associated with operational parameters relating to extraction and transportation activities of the multiphase fluid;
a processor and memory storing instructions that, when executed by the processor, cause the processor to:
determine a plurality of slug catcher sizes of the slug catcher, comprising:
determining a first slug catcher size of the plurality of slug catcher sizes based on a hydrodynamic slugging scenario of the network model using a first subset of values of the operational parameters, wherein the first slug catcher size is a first function of travel distance of the multiphase fluid and is determined based on a probabilistic model of the extraction and transportation activities, and
determining a second slug catcher size of the plurality of slug catcher sizes based on a ramp-up scenario of the network model using a second subset of values of the operational parameters, wherein the second slug catcher size is determined based on sensitivity of liquid holdup with respect to overall flow rate induced by increases of input flow rate of the pipeline network,
wherein the first slug catcher size and the second slug catcher size are determined by performing (i) a successive steady-state analysis of the multiphase fluid using a first mass conservation equation, an energy conservation equation, and a momentum conservation equation of the multiphase fluid that are based on a steady-state and (ii) a simplified transient analysis of the multiphase fluid using a second mass conservation equation of the multiphase fluid that is time dependent and using the energy conservation equation and the momentum conservation equation of the multiphase fluid that are based on the steady-state,
generate a hydrodynamic slugging plot and a ramp-up analysis plot based on the first slug catcher size and the second slug catcher size, respectively;
generate, using selected values of the operational parameters from a user, a combined scenario plot based on the hydrodynamic slugging plot and the ramp-up analysis plot; and
a display device configured to display the combined scenario plot for the user, wherein the size of the slug catcher is selected from the plurality of slug catcher sizes by the user based on an evaluation of the combined scenario plot.

11. The system of claim 10, wherein the instructions further cause the processor to:
identify a limiting parameter from the first subset and the second subset of values of the operational parameters, wherein the limiting parameter imposes a worst case slug catcher size requirement for the plurality of slug catcher sizes;
receive, from the user, a constraint of the limiting parameter to mitigate the worst case slug catcher size requirement, wherein the constraint is identified based on at least the evaluation of the combined scenario plot by the user; and
adjust, prior to the user selecting the size of the slug catcher, the first slug catcher size and the second slug catcher size by further performing the successive steady-state analysis and the simplified transient analysis of the multiphase fluid based on the constraint.

12. The system of claim 10,
wherein determining the plurality of slug catcher sizes further comprises:
determining a third slug catcher size of the plurality of slug catcher sizes based on a pigging scenario of the network model using a third subset of values of the operational parameters, wherein the third slug catcher size is determined based on liquid holdup of the multiphase fluid caused by performing a pigging operation in the pipeline network,
wherein determining the third slug catcher size comprises performing the successive steady-state analysis of the multiphase fluid using the first mass conservation equation, the energy conservation equation, and the momentum conservation equation of the multiphase fluid that are based on the steady-state, and
wherein the instructions further cause the processor to:
generate a pigging analysis plot based on the third slug catcher size,
wherein the combined scenario plot is further generated based on the pigging analysis plot.

13. The system of claim 12,
wherein determining the plurality of slug catcher sizes further comprises:
determining a fourth slug catcher size of the plurality of slug catcher sizes based on a severe slugging scenario of the network model using a fourth subset of values of the operational parameters, wherein the fourth slug catcher size is determined based on a volume of a riser in the pipeline network,
wherein determining the fourth slug catcher size comprises performing the successive steady-state analysis of the multiphase fluid using the first mass conservation equation, the energy conservation equation, and the momentum conservation equation of the multiphase fluid that are based on the steady-state, and
wherein the instructions further cause the processor to:
generate a severe slugging analysis plot based on the fourth slug catcher size,
wherein the combined scenario plot is further generated based on the severe slugging analysis plot.

14. The system of claim 13, wherein the instructions further cause the processor to:
iteratively identify a limiting parameter from the first subset, the second subset, the third subset, the fourth subset, and the fifth subset of values of the operational parameters, wherein the limiting parameter imposes a worst case slug catcher size requirement for the plurality of slug catcher sizes;
iteratively receive, from the user, a constraint of the iteratively identified limiting parameter, wherein the iteratively received constraint is identified by the user based on an iterative evaluation of the combined scenario plot;
adjust, prior to the user selecting the size of the slug catcher, the first slug catcher size, the second slug catcher size, the third slug catcher size, and the fourth slug catcher size by iteratively performing the successive steady-state analysis and the simplified transient analysis of the multiphase fluid based on the iteratively received constraint; and
include a version of the iteratively received constraint in a field operation plan corresponding to the size of the slug catcher selected by the user.

15. The system of claim 13,
wherein each of the hydrodynamic slugging plot, the pigging analysis plot, the instantaneous ramp-up analysis plot, the gradual ramp-up analysis plot, and the severe slugging analysis plot comprises a trend plot and a system plot,
wherein the trend plot comprises calculated output liquid rate as a second function of time and calculated slug catcher inventory as a third function of time,
wherein the second function and the third function are parameterized functions with respect to a turn down ratio, and
wherein the system plot comprises a calculated slug catcher size as a fourth function of the turn down ratio.

16. A non-transitory computer readable storage medium storing instructions for determining a size of a slug catcher in a pipeline network configured for extracting and transporting multiphase fluid from a reservoir in a subterranean formation, the instructions when executed causing a processor to:
obtain a network model of the pipeline network, wherein the network model comprises a geometry of the pipeline network and characteristics of an equipment associated with the pipeline network;
obtain operational parameters of the pipeline network, wherein the operational parameters relate to extraction and transportation activities of the multiphase fluid;
determine a plurality of slug catcher sizes of the slug catcher, comprising:
determining a first slug catcher size of the plurality of slug catcher sizes based on a hydrodynamic slugging scenario of the network model using a first subset of values of the operational parameters, wherein the first slug catcher size is a first function of travel distance of the multiphase fluid and is determined based on a probabilistic model of the extraction and transportation activities, and
determining a second slug catcher size of the plurality of slug catcher sizes based on a pigging scenario of the network model using a second subset of values of the operational parameters, wherein the second slug catcher size is determined based on liquid holdup of the multiphase fluid caused by performing a pigging operation in the pipeline network,
wherein the first slug catcher size and the second slug catcher size are determined by performing a successive steady-state analysis of the multiphase fluid using a first mass conservation equation, an energy conservation equation, and a momentum conservation equation of the multiphase fluid that are based on a steady-state,
generate a hydrodynamic slugging plot and a pigging analysis plot based on the first slug catcher size and the second slug catcher size, respectively;
generate, using selected values of the operational parameters from a user, a combined scenario plot based on the hydrodynamic slugging plot and the pigging analysis plot; and
display the combined scenario plot for the user, wherein the size of the slug catcher is selected from the plurality of slug catcher sizes by the user based on an evaluation of the combined scenario plot.

17. The non-transitory computer readable storage medium of claim 16, the instructions when executed further cause a processor to:
identify a limiting parameter from the first subset and the second subset of values of the operational parameters, wherein the limiting parameter imposes a worst case slug catcher size requirement for the plurality of slug catcher sizes;
receive, from the user, a constraint of the limiting parameter to mitigate the worst case slug catcher size requirement, wherein the constraint is identified based on at least the evaluation of the combined scenario plot by the user;
adjust, prior to the user selecting the size of the slug catcher, the first slug catcher size and the second slug catcher size by further performing the successive steady-state analysis of the multiphase fluid based on the constraint; and
include the constraint in a field operation plan corresponding to the size of the slug catcher selected by the user.

18. The non-transitory computer readable storage medium of claim 16,
wherein determining the plurality of slug catcher sizes further comprises:
determining a third slug catcher size of the plurality of slug catcher sizes based on an instantaneous ramp-up scenario of the network model using a third subset of values of the operational parameters, wherein the third slug catcher size is determined based on sensitivity of liquid holdup with respect to overall flow rate induced by increases of input flow rate of the pipeline network, and
wherein determining the third slug catcher size comprises performing the successive steady-state analysis of the multiphase fluid using the first mass conservation equation, the energy conservation equation, and the momentum conservation equation of the multiphase fluid that are based on the steady-state, and
wherein the method further comprises:
generating an instantaneous ramp-up analysis plot based on the third slug catcher size,
wherein the combined scenario plot is further generated based on the instantaneous ramp-up analysis plot.

19. The non-transitory computer readable storage medium of claim 18,
wherein determining the plurality of slug catcher sizes further comprises:
determining a fourth slug catcher size of the plurality of slug catcher sizes based on a gradual ramp-up scenario of the network model using a fourth subset of values of the operational parameters, wherein the fourth slug catcher size is determined based on sensitivity of liquid holdup with respect to overall flow rate induced by increases of input flow rate of the pipeline network, and
wherein determining the fourth slug catcher size comprises performing a simplified transient analysis of the multiphase fluid using a second mass conservation equation of the multiphase fluid that is time dependent and using the energy conservation equation and the momentum conservation equation of the multiphase fluid that are based on the steady-state, and
wherein the method further comprises:
generating a gradual ramp-up analysis plot based on the fourth slug catcher size,
wherein the combined scenario plot is further generated based on the gradual ramp-up analysis plot.

20. The non-transitory computer readable storage medium of claim 19,
wherein determining the plurality of slug catcher sizes further comprises:
determining a fifth slug catcher size of the plurality of slug catcher sizes based on a severe slugging scenario of the network model using a fifth subset of values of the operational parameters, wherein the fifth slug catcher size is determined based on a volume of a riser in the pipeline network; and
wherein determining the fifth slug catcher size comprises performing the successive steady-state analysis of the multiphase fluid using the first mass conservation equation, the energy conservation equation, and the momentum conservation equation of the multiphase fluid that are based on the steady-state, and
wherein the method further comprises:
generating a severe slugging analysis plot based on the fifth slug catcher size,
wherein the combined scenario plot is further generated based on the severe slugging analysis plot.
